(19) United States
(12) Patent Application Publication
(10) Pub. No.: US 2009/0317303 A1
(43) Pub. Date: Dec. 24, 2009

(54) FLEXIBLE DISPOSABLE TIP INTERFACE

(75) Inventors: Renato Belz, Emmenbrucke (CH); Carsten Haack, Huenenberg See (CH)

Correspondence Address: Roche Molecular Systems, Inc.;Patent Law Department, 4300 Hacienda Drive, Pleasanton, CA, 94588, US

(73) Assignee: Roche Molecular Systems, Inc., Pleasanton, CA (US)

(21) Appl. No.: 12/488,748

(22) Filed: Jun. 22, 2009

(30) Foreign Application Priority Data
Jun. 24, 2008 (EP) 08104530.4

(51) Int. Cl. B01L 3/02; B29C 45/00

(52) U.S. Cl. 422/100; 264/328.1

(57) ABSTRACT

A disposable pipette tip for releasably connecting with a pipette shaft is described, comprising an elongated flexible tubular interface having a central axis for connecting the pipette tip to the pipette shaft and an elongated tubular part extending from a distal tip opening to said tubular interface, wherein said elongated flexible tubular interface has a strain of more than of more than about 20% and wherein the extensibility of said elongated flexible tubular interface is reversible.

### CROSS-REFERENCE TO RELATED APPLICATION

The present application claims the benefit of EP Appl. No. 08104530.4 filed Jun. 24, 2008, the content of which is hereby incorporated herein by reference in its entirety.

### FIELD OF THE INVENTION

The present invention relates to a disposable pipette tip for releasably connecting with a pipette shaft.

### DESCRIPTION OF PRIOR ART

Disposable pipette tips are used to receive and dispense liquids. Such pipette tips are particularly useful for receiving and dispensing small volumes of liquid. For pipetting, the shaft of a pipette is connected to an elongated rigid tubular interface of the pipette tip. Following pipetting, the pipette tip is released from the shaft of the pipette and discarded.

Disposable pipette tips are well known in the art. Usually, pipette tips are produced with injection molding techniques using thermoplastic materials. Such thermoplastic materials have a limited elasticity. They commonly have a rigid interface for connecting with the pipette shaft.

U.S. Pat. No. 4,072,330 discloses a pipette tip interface with a deformable conical sealing zone which is obtained by reduction of the wall thickness. This renders the pipette tip more fragile and prone to damage.

In particular in automated systems, it is difficult to achieve precision of the orientation of the pipette shaft and the pipette tip with respect to the vessel comprising the sample using pipette tips known in the art. If the shaft does not correctly align with the rigid pipette tip interface, the connection may not be leak tight, leading to imprecision when pipetting a liquid.

### SUMMARY OF THE INVENTION

In a first aspect, the invention relates to a disposable pipette tip for releasably connecting with a pipette shaft, comprising an elongated flexible tubular interface having a central axis for connecting the pipette tip to the pipette shaft, and an elongated tubular part extending from a distal tip opening to said tubular interface, wherein said elongated flexible tubular interface comprises at least one section having a geometry providing a horizontal strain of said section of said elongated flexible tubular interface of more than about 20% and wherein the extensibility of said section of said elongated flexible tubular interface is reversible, and wherein said disposable pipette tip is made of polypropylene.

In a second aspect, the invention relates to a rack for storing pipette tips, wherein said rack comprises pipette tips according to the invention.

In a third aspect, the invention relates to a method of producing a disposable pipette tip according to the invention, comprising the step of 1-compound injection molding using a mold which is of a shape that protrusions are formed on the inside surface of an elongated flexible tubular interface of said pipette tip.

In a fourth aspect, the invention relates to a system for pipetting liquid samples, comprising a disposable pipette tip according to the invention, and a pipette comprising a pipette shaft for connecting to a pipette tip, wherein said pipette shaft is connected to said pipette tip to pipette liquid samples.

In a fifth aspect, the invention relates to a process of connecting a pipette to a pipette tip, comprising the steps of
connecting the pipette shaft of a pipette with a pipette tip according to the invention,
fitting the pipette tip to the pipette shaft by extending the diameter of the elongated flexible tubular interface of the pipette tip to adapt to the diameter of the pipette shaft, and
providing liquid tightness by pressing the bottom surface of the pipette shaft to a ring shaped planar sealing surface extending from the opening of said elongated flexible tubular interface proximal to said elongated part to the opening of said elongated tubular part proximal to said elongated flexible tubular interface, and wherein, proximal to said ring-shaped planar sealing surface, the radius of said elongated flexible tubular interface is larger than the radius of said elongated tubular part.

In a sixth aspect, the invention relates to a process for pipetting liquid samples, comprising the steps of:
a) connecting a pipette to a pipette tip according to the invention,
b) withdrawing liquid from a storage vessel,
c) dispensing said liquid into a new vessel by applying pneumatic pressure,
d) removing said pipette tip by mechanical pressure exerted by a solid part on the upper surface of the elongated flexible tubular interface of said pipette tip, and
e) connecting a pipette to said pipette tip, and repeating steps b) to d),
   wherein step e) is performed at least once.

In a seventh aspect, the invention relates to an analytical system comprising at least one module which comprises the pipette tips of the invention.

### BRIEF DESCRIPTION OF THE FIGURES

FIG. 1 shows a two-dimensional surface view of a disposable pipette tip according to the invention.

FIGS. 2 a-b show perspective views of one embodiment of a flexible interface of a disposable pipette tip in a relaxed (FIG. 2a) and a dilated state (FIG. 2b).

FIGS. 3 a-c show top views (T) of different embodiments (FIG. 3a) to (FIG. 3c) of the structure of the interface, and a two-dimensional side view (S) of the corresponding surfaces of the interface.

FIGS. 4 a-b show the interaction of pipette shaft and pipette tip interface (FIG. 4a), and of pipette shaft and planar sealing surface (FIG. 4b).

FIGS. 5 a-c schematically show a comparison of strain of the basic material of the pipette tip (FIG. 5a), an undulated geometry (FIG. 5b) and a net-like two dimensional geometry (FIG. 5c). On top, the relaxed material is shown, and on the bottom, the extended material is shown.

FIG. 6 shows a schematic view of an analytical system comprising a storage module, a processing module and a detection module.

FIGS. 7 a-b show two embodiments of pipette tips with interfaces comprising section with material with and without a flexible geometry either perpendicular (FIG. 7a) or parallel to the axis of the tip (FIG. 7b).

### DETAILED DESCRIPTION OF THE INVENTION

As mentioned hereinabove, the present invention provides a disposable pipette tip for releasably connecting with a pipette shaft which comprises an elongated flexible tubular interface having a central axis for connecting said pipette tip to the pipette shaft. Said disposable pipette tip additionally comprises an elongated tubular part extending from a distal tip opening to said tubular interface. The elongated flexible tubular interface of said disposable pipette tip comprises at least one section which has a geometry which provides a strain of said section of said elongated flexible tubular interface of more than about 20% and wherein the extensibility of said section of said elongated flexible tubular interface is reversible. In a certain embodiment, said strain is more than 30%. In another embodiment, said strain is more than 40%.

According to the present invention, an “analyte” is understood to be a substance of interest, e.g. a nucleic acid of interest or a protein of interest which is investigated and its presence or absence, or its concentration in a biological sample is determined as its presence or absence is indicative of a certain condition or disease of a human or animal. In a certain embodiment, said analyte is a biological analyte, for example a nucleic acid. Said nucleic acid may be RNA or DNA or any derivative thereof.

The term “fluid” as used herein relates to any kind of solution used in analytical tests. A fluid may include fluid biological samples such as blood, serum, sputum, cerebral fluid, urine, or any type of soluble reagent used for preparing or processing said analyte.

The term “biological sample” as used herein relates to any sample derived from a biological organism. In an embodiment of the invention, the biological sample comprises viruses or bacterial cells, as well as isolated cells from multicellular organisms as e.g. human and animal cells such as leucocytes, and immunologically active low and high molecular chemical compounds such as haptens, antigens, antibodies and nucleic acids, blood plasma, cerebral fluid, sputum, stool, biopsy specimens, bone marrow, oral rinses, blood serum, tissues, urine or mixtures thereof. Thus, the biological sample may be either solid or fluid. In a certain embodiment of the invention the biological sample is a fluid from the human or animal body. A biological sample which is a fluid is also called a sample fluid. In a certain embodiment the biological sample is blood, blood plasma, blood serum or urine. The blood plasma is for example EDTA-, heparin- or citrate-treated blood plasma. In an embodiment of the invention the biological sample comprises bacterial cells, eukaryotic cells, viruses or mixtures thereof. In a certain embodiment of the invention, the virus is the hepatitis A virus (HAV), hepatitis B virus (HBV), hepatitis C virus (HCV), the human immunodeficiency virus (HIV), the human papilloma virus (HPV) or parvovirus B19. The biological sample can also be of a type used for environmental analysis, food analysis or molecular biology research, e.g. from bacterial cultures or phage lysates.

The term “releasably” as used herein relates to the interaction between pipette tip and pipette shaft being releasable, i.e. the pipette tip, after connecting to the pipette shaft, may be released again.

The term “elongated flexible tubular interface” as used herein relates to the part of the pipette tip which is brought into direct contact with a pipette shaft when the pipette tip is connected to the pipette shaft. The term “tubular” is meant to describe a conical or cylindrical shaped structure with an empty interior through which liquid or air can pass. The term “elongated” relates to the fact that the interface extends over a distance sufficient to properly connect with a pipette shaft. The terms “elongated flexible tubular interface” and “interface” are used interchangeably herein.

The term “pipette shaft” relates to the part of a pipette for transferring liquids capable of connecting directly with a pipette tip. Said connection with the interface can be either from the inside or the outside of the interface. Thus, in a certain embodiment, when connecting with the interface, the pipette shaft enters the inside of the flexible tubular interface of the pipette tip and causes the interface to extend. In another embodiment, the pipette shaft grips the interface from the outside. In yet another embodiment of the pipette shaft hereinbefore described, said pipette shaft forms part of a robotic pipetting system. Said robotic pipetting system may comprise more than one pipette shafts which can interact with a pipette interface hereinbefore described.

The term “strain” as used herein relates to a measure of the flexibility of an object. The relative strain, ε, is given by the formula:

ε=(l−l₀)/l₀

where ε is the relative strain in measured direction, l₀ is the original length of the material and l is the current length of the material. The strain ε_{F∞} of a material is, therefore, understood to be the elastic limit. This limit defines the transition between fully reversible elastic deformation of a material and plastic deformation which is not reversible. For common polymers, strain or ε_{F∞} is <5%. e.g. for PVC (polyvinyl-chloride), ε_{F∞} is 0.8%; for polycarbonate (PC), ε_{F∞} is 0.4%, and for polypropylene (PP), ε_{F∞} is between 2.0 and 2.5%.

The term “geometry” as used herein relates to the three-dimensional structure of the interface. The extensibility or strain of the pipette tip is, thus, not achieved by using an elastic material for making the interface, but by the structure of the interface itself. However, it is within the scope of the present invention that parts of the interface or all of the interface may comprise an elastic material, such as rubber, which has a geometry which produces an increased strain compared to just the strain of the elastic material itself. Non-limiting examples for geometries of the interface are protrusions, or a net-like structure of the interface.

In a certain embodiment, the strain is a horizontal strain.

The term “reversible” as used herein relates to the reversibility of strain of the interface. When interacting with a pipette shaft, the flexible interface of the pipette tip is extended. When, subsequently, the pipette tip is released from the pipette shaft, the interface returns into its original relaxed state, and can be reused. This means that a pipette shaft can be connected to and released from one pipette tip repeatedly. This allows reusing the pipette tips at least once.

The term “section” as used herein relates to a segment or part of the tubular interface which has a geometry and strain as described herein before. This means that the tubular interface may comprise parts with said geometry and parts without said geometry. In a certain embodiment, the parts without said geometry lack the flexibility defined by the geometry. Said sections may be arranged axially (i.e. in parallel with the axis of the tubular interface) or they may be for example arranged perpendicular to said axis. Thus, the tubular interface may, in a certain embodiment, comprise parts which are more solid, and parts which are flexible. In another embodiment, the entire tubular interface has a geometry as described herein.

In a certain embodiment, said tubular interface has a constant wall thickness.

The term “constant wall thickness” relates to the thickness of the wall of the interface described herein above and below. “Constant” means that the wall thickness is substantially identical over the whole interface. In a certain embodiment, said wall thickness is identical over the whole interface. “Identical” includes some variability due to production processes.

In another embodiment, the interface hereinbefore described has a sealing zone and a gripping zone, wherein said gripping zone has at least one section which has a geometry which provides a strain as hereinbefore described. The sealing zone is deprived of such a geometry as hereinbefore described. Thus, when strained, the sealing zone is irreversibly deformable.

When interacting a pipette shaft with a disposable pipette tip comprising an elongated flexible tubular interface according to the present invention, the connection between pipette tip and interface is leak-tight, even if the orientation of the shaft and the interface is not optimal, due to the flexibility of the interface. The flexibility of the interface of the pipette tip according to the present invention further prevents the pipette shaft from interacting too tightly with the interface and facilitates the removal of the pipette tip following pipetting. This also prevents damaging the tip material, thus also allowing reuse of the pipette tip.

Said pipette shaft can be a cannula through which the liquid is aspirated, or it can be a pipette shaft which exerts pneumatic pressure for aspirating liquid into the pipette tip according to the invention, and for subsequently dispensing said liquid into a vessel.

In a certain embodiment of the pipette tip hereinbefore described, said elongated flexible tubular interface comprises protrusions on the inside surface. In another embodiment, said elongated flexible tubular interface additionally comprises protrusions on the outside surface. In another embodiment of the pipette tip hereinbefore described, said protrusions are arranged in a one- or two-dimensional pattern. One- or two dimensional patterns can be selected from ribs, undulated protrusions or a two-dimensional rhomboid shape.

Thus, the term “protrusions” as used herein relates to ribbed or undulated surfaces of the interface which are protrusions relative to a virtual cylindrical or conical surface of said interface.

In a certain embodiment the elongated flexible tubular interface of the pipette tip comprises protrusions on the inside surface, and sometimes additionally on the outside surface. The protrusions are arranged as one- or two-dimensional ribs. In a certain embodiment, the orientation of the one- or two-dimensional ribs is radial. In another embodiment, the orientation of the ribs is axial. In yet another embodiment, said protrusions may be snap-fits extending from the surface of the pipette tip towards its axis.

In a certain embodiment of the disposable pipette tip hereinbefore described, said elongated flexible tubular interface is connected to said elongated tubular part by a ring-shaped planar sealing surface. This ring-shaped planar sealing surface extends from the opening of the elongated flexible tubular interface which is in a proximal location relative to the elongated part to the opening of the elongated tubular part proximal to said elongated flexible tubular interface. Furthermore, proximal to said ring-shaped planar sealing surface, the radius of said elongated flexible tubular interface is larger than the radius of said elongated tubular part. Thus, the ring-shaped planar sealing surface is a connection between the tubular interface and the elongated tubular lower part of the pipette tip. When the pipette shaft is connected to the pipette tip, the bottom surface of the shaft is pressed against the ring-shaped surface described hereinbefore, providing liquid-tightness. Consequently, this allows for a separation of the functions of gripping and providing liquid-tightness. Gripping is achieved by the interaction between the pipette shaft and the interface, while liquid-tightness is achieved by interacting the bottom of the shaft with said ring-shaped planar sealing surface hereinbefore described. This has the advantage that the functions of holding and of liquid-tightness between pipette shaft and pipette tip can be optimized separately.

The elongated flexible tubular interface and the elongated tubular part of the pipette tip of the present invention may be made of different materials.

In a certain embodiment of the disposable pipette tip hereinbefore described, said elongated flexible tubular interface is made of the same material as the elongated tubular part. In another embodiment, said pipette tip is a 1-compound injection molded pipette tip.

Thus, the flexibility of the tubular interface can be achieved by the structure of the surface of the interface alone, even with the same material used commonly for the production of pipette tips with a rigid tubular interface. Commonly, pipette tips are produced with injection molding techniques using thermoplastic materials (polymers). One such material is polypropylene. Thermoplastic materials are, however, limited in elasticity. Typically, the yield strain of such materials is about 5-10%. The pipette tip interfaces according to the present invention which have an increased strain due to the geometry of the interface structure when using those same materials can, thus, still return to their original shape when exposed to higher strains. Furthermore, since this effect can be achieved with a pipette tip wherein the elongated flexible tubular interface is made of the same material as the elongated tubular part, it is not necessary to use more laborious 2-component molding to combine rigid and flexible materials.

The present invention also relates to a rack for storing pipette tips, wherein said rack comprises pipette tips hereinbefore described.

Furthermore, the present invention relates to a method of producing a disposable pipette tip hereinbefore described, comprising the step of compound injection molding using a mold which is of a shape that protrusions are formed on the inside surface and/or outside surface of an elongated flexible tubular interface of said pipette tip.

Compound injection molding techniques are well known in the art. Thus, the present invention allows the use of common and cost-efficient production methods as well as the use of materials compliant with regulatory requirements for diagnostic applications for the production of the pipette tips hereinbefore described.

In a certain embodiment, said protrusions have a geometry as described hereinbefore.

In certain embodiments pipette tips according to the present invention are pipette tips with an interface having a diameter of about 1 to about 20 mm and a volume of about 10 μl to about 5 ml.

The present invention further relates to a system for pipetting liquid samples, comprising:
a disposable pipette tip as hereinbefore described, and
a pipette comprising a pipette shaft for connecting to a pipette tip,
   wherein said pipette shaft can be connected to said pipette tip to pipette liquid samples. In a certain embodiment, said system additionally comprising at least one rack as described hereinbefore.

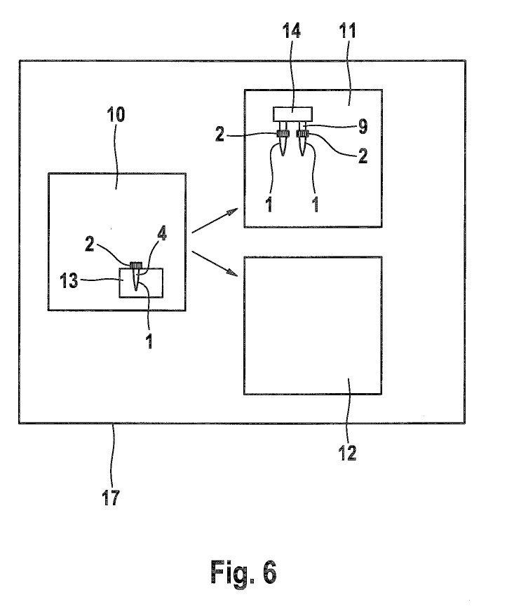

Referring now to FIG. 6, the present invention also relates to an analytical system (17) comprising at least one module which comprises the pipette tips (1) of the present invention. Said system can comprise a storage module (10), which comprises the pipette tips of the present invention stacked in racks (13) holding said tips. Said system furthermore, may comprise a processing module (11) comprising a pipetting device (14) with one or more pipetting shafts (9) capable of connecting to the pipette tips (1) of the present invention. A biological sample comprising a biological analyte contained in a liquid is processed with said processing module. Said liquid is contained in a reaction receptacle. Said processing may comprise transferring liquids with a pipetting device (14) wherein a pipette tip (1) according to the present invention is connected to a pipette shaft (9) of the pipetting device (14). Said transfer of liquids may comprise addition of liquids by aspirating said liquids into pipette tips (1) of the present invention, and transferring said liquids to a reaction receptacle by dispensing the liquid contents in said pipette tip. Said transfer of liquids may also comprise mixing of liquids achieved by aspirating and dispensing through a pipette tip (1) according to the present invention. In a certain embodiment, said mixing of liquids comprises mixing of a suspension of particles for binding a biological analyte and a liquid in which said particles are contained. In a certain embodiment, said particles are magnetic particles. In a certain embodiment, said magnetic particles are magnetic glass particles, and if the analyte is a nucleic acid, magnetic glass particles comprising an unmodified silica surface. Certain embodiments of said magnetic glass particles are disclosed in WO 96/41811. Suitable magnetic glass particles according to the invention are manufactured according to the international application EP1154443 which are also provided in the MagNA Pure LC DNA Isolation Kit I (Roche, Mannheim, Germany)). They are also produced by the sol-gel-method as described in the international application (EP 1154443) using magnetic objects or pigments with a diameter of about 23 nm (manufactured by CERAC consisting of γ-Fe2O3; CERAC: P.O. Box 1178, Milwaukee, Wis. 53201-1178 USA; Article-No. I-2012).

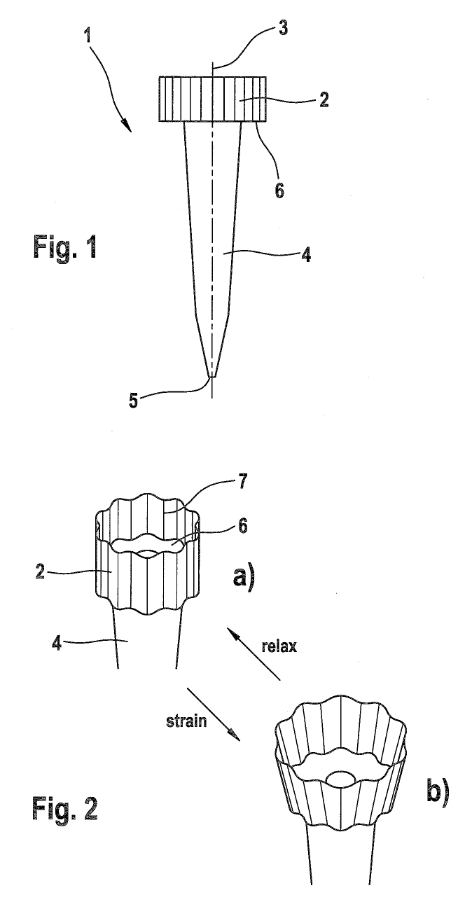

FIG. 1 shows a disposable pipette tip (1) for releasably connecting with a pipette shaft, comprising an elongated flexible tubular interface (2) having a central axis (3) for connecting the pipette tip to the pipette shaft, and an elongated tubular part (4) extending from a distal tip opening (5) to said tubular interface (2).

FIG. 2a shows a relaxed elongated flexible tubular interface (2) with protrusions (7) which provide flexibility to the interface. A ring shaped planar sealing surface (6) extending from the opening of the elongated flexible tubular interface (2) proximal to the elongated part (4) to the opening of elongated tubular part (4) proximal to the elongated flexible tubular interface (2). FIG. 2b shows a strained elongated flexible tubular interface (2).

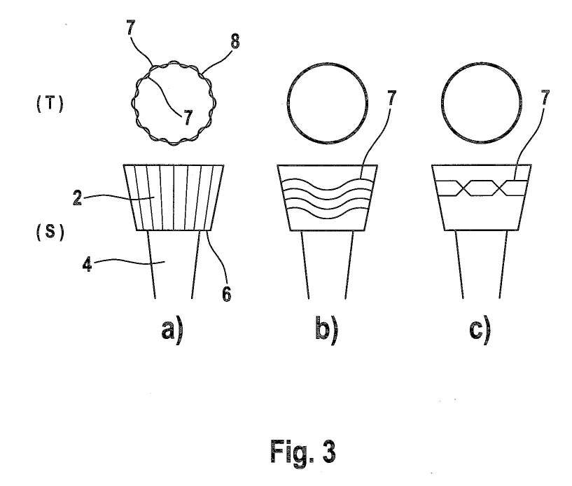

FIG. 3 shows three embodiments of the present invention. In the upper part (T), a horizontal section through the interfaces is shown. FIG. 3a shows a ribbed surface having protrusions (7) extending towards the outside and the inside of the interface, relative to a virtual surface of the interface (8). The shape of the virtual interface (8) may be conical or cylindrical. The bottom picture of embodiment (a) shows a two-dimensional view of the interface from the side. Embodiment of FIG. 3b has a two-dimensional ribbed surface in side view (S) shown in the bottom drawing. Embodiment of FIG. 3c has a two-dimensional rhomboid pattern on the surface of the interface (2).

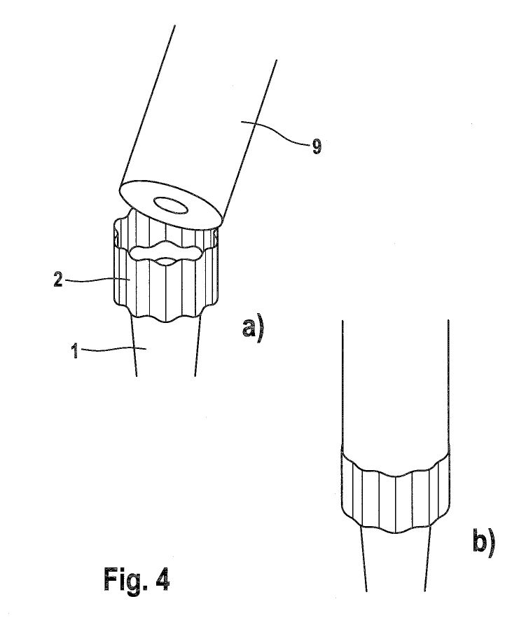

FIG. 4 shows an interaction of a pipette shaft with an interface with an undulated geometry. In FIG. 4a the interface is shown before interaction with the pipette shaft. In FIG. 4b the interface is connected to the pipette shaft.

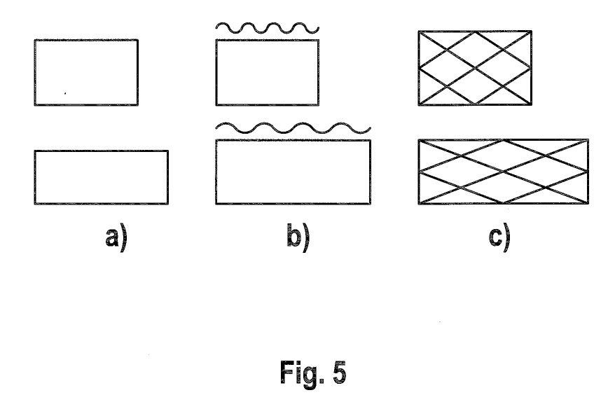

FIG. 5 shows schematically how the strain differs between basic material and material according to the present invention. FIG. 5a shows the basic material with a smooth surface. The strain amounts to about 4%. FIG. 5b shows an undulated surface. The strain amounts to about 40 to about 50%. FIG. 5c shows a net-like geometry of a material with a strain of about 40 to about 50%. The schematic figures illustrate how the change of geometry of the same material leads to an increased extensibility of the materials.

FIG. 6 shows schematically an analytical system (17). Said system comprises a storage module (10). Said storage module stores racks (13) comprising pipette tips (1) with an interface (2) as described hereinbefore. Said storage rack provides pipette tips (1) to other modules of said analytical system. Said modules may comprise a processing module (11) which comprises at least one pipetting device (14). The pipetting device comprises at least one pipette shaft (9) which can interact with the pipette tips (1). The system may further comprise a detection module (12).

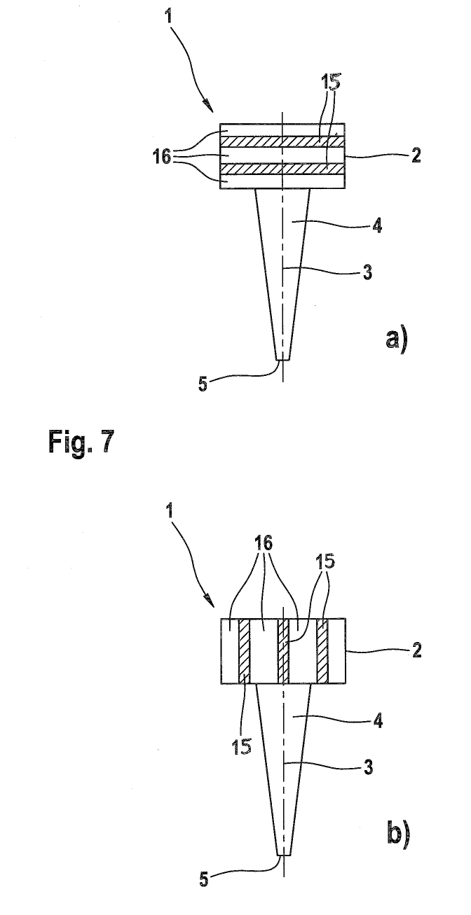

FIG. 7 shows a pipette tip with an interface comprising sections with or without flexible geometry. FIG. 7a shows a tip (1) with an interface (2) which comprises sections (16) with a flexible geometry and sections (15) without a flexible geometry which are arranged perpendicular to the axis (3). FIG. 7b shows a tip (1) with an interface (2) which comprises sections (16) with a flexible geometry and sections (15) without a flexible geometry which are arranged in parallel to the axis (3).

The analytical system according to the invention may further comprise a detection module. In a certain embodiment, said detection module is a combined nucleic acid amplification and detection module.

In a certain embodiment of said analytical system, said system comprises at least one robotic pipetting system. The robotic pipetting system comprises pipette shafts which can interact with the elongated flexible tubular interface of pipette tips hereinbefore described. The interaction of the pipette shafts with the interfaces according to the present invention in such a system leads to improved robotic tolerances and reliability. In addition, the interaction does not damage the interface of the pipette tips, and the pipette tips can, thus, be reused.

The present invention also relates to a process of connecting a pipette to a pipette tip. This process comprises connecting the pipette shaft of said pipette with a pipette tip hereinbefore described. When connecting the pipette shaft to the pipette tip, the pipette tip is being fitted to the pipette shaft by extending the diameter of the elongated flexible tubular interface of the pipette tip. This extension allows adapting the interface to the diameter of the pipette shaft. Furthermore, the process comprises the step of providing liquid tightness. Liquid tightness is achieved by pressing the bottom surface of the pipette shaft to a ring shaped planar sealing surface. This ring-shaped planar sealing surface connects the interface and the lower tubular part of the pipette tip. The ring-shaped planar sealing surface extends from the opening of said elongated flexible tubular interface proximal to said elongated part to the opening of said elongated tubular part proximal to said elongated flexible tubular interface. Thus, proximal to said ring-shaped planar sealing surface, the radius of said elongated flexible tubular interface is larger than the radius of said elongated tubular part.

Furthermore, the present invention provides a process for pipetting liquid samples, comprising:
connecting a pipette to a pipette tip as described hereinbefore,
aspirating liquid from a storage vessel,
dispensing said liquid into a new vessel by applying pneumatic pressure, and
removing said pipette tip by mechanical pressure exerted by a solid part on the upper surface of the elongated flexible tubular interface of said pipette tip. In a certain embodiment, the steps are repeated using the same pipette tip. Thus, the pipette tip is used repeatedly for the pipetting process.

It is understood that the examples and embodiments described herein are for illustrative purposes only and are not intended to limit the scope of the claimed invention. It is also understood that various modifications or changes in light the examples and embodiments described herein will be suggested to person skilled in the art and are to be included within the spirit and purview of this application and scope of the appended claims.

### REFERENCE NUMERALS

| | |
|---|---|
| 1 | Tip |
| 2 | Interface |
| 3 | Axis of the elongated flexible tubular interface |
| 4 | Elongated tubular part |
| 5 | Distal tip opening |
| 6 | Ring shaped planar sealing surface |
| 7 | Protrusions |
| 8 | Interface |
| 9 | Pipette shaft |
| 10 | Storage module |
| 11 | Processing module |
| 12 | Detection module |
| 13 | Racks |
| 14 | Pipetting device |
| 15 | Sections without a flexible geometry |
| 16 | Sections with a flexible geometry |
| 17 | Analytical system |

While the foregoing invention has been described in some detail for purposes of clarity and understanding, it will be clear to one skilled in the art from a reading of this disclosure that various changes in form and detail may be made without departing from the true scope of the invention. For example, the systems and methods described above may be used in various combinations. All publications cited in this application are incorporated by reference in their entirety for all purposes to the same extent as if each individual publications were individually indicated to be incorporated by reference for all purposes.

1. A disposable pipette tip for releasably connecting with a pipette shaft, comprising:
an elongated flexible tubular interface having a central axis for connecting the pipette tip to the pipette shaft, and
an elongated tubular part extending from a distal tip opening to said tubular interface,
wherein said elongated flexible tubular interface comprises at least one section having a geometry providing a horizontal strain of said section of said elongated flexible tubular interface of more than about 20% and wherein the extensibility of said section of said elongated flexible tubular interface is reversible, and wherein said disposable pipette tip is made of polypropylene.

2. The disposable pipette tip according to claim 1, wherein said geometry comprises protrusions on the inside surface or a net-like structure of the interface.

3. The disposable tip of claim 1, wherein said geometry comprises protrusions on the outside surface.

4. The disposable pipette tip of claim 1, wherein said protrusions are arranged in a one- or two-dimensional pattern.

5. The disposable pipette tip of claim 2, wherein said protrusions are selected from the group consisting of ribs, undulated protrusions and protrusions having a two-dimensional rhomboid shape.

6. The disposable pipette tip of claim 5, wherein the orientation of said ribs is radial or axial.

7. The disposable pipette tip of claim 1, wherein said elongated flexible tubular interface is connected to said elongated tubular part by a ring-shaped planar sealing surface extending from the opening of said elongated flexible tubular interface proximal to said elongated part to the opening of said elongated tubular part proximal to said elongated flexible tubular interface, and wherein, proximal to said ring-shaped planar sealing surface, the radius of said elongated flexible tubular interface is larger than the radius of said elongated tubular part.

8. The disposable pipette tip of claim 1, wherein said pipette tip is a 1-compound injection molded pipette tip.

9. A rack for storing pipette tips, wherein said rack comprises pipette tips according to claim 1.

10. A method of producing a disposable pipette tip according to claim 1, comprising the step of 1-compound injection molding using a mold which is of a shape that protrusions are formed on the inside surface of an elongated flexible tubular interface of said pipette tip.

11. A system for pipetting liquid samples, comprising:
a disposable pipette tip according to claim 1, and
a pipette comprising a pipette shaft for connecting to a pipette tip,
wherein said pipette shaft is connected to said pipette tip to pipette liquid samples.

12. The system of claim 11, further comprising at least one rack according to claim 8.

13. A process of connecting a pipette to a pipette tip, comprising the steps of:
connecting the pipette shaft of a pipette with a pipette tip according to claim 1,
fitting the pipette tip to the pipette shaft by extending the diameter of the elongated flexible tubular interface of the pipette tip to adapt to the diameter of the pipette shaft, and
providing liquid tightness by pressing the bottom surface of the pipette shaft to a ring shaped planar sealing surface extending from the opening of said elongated flexible tubular interface proximal to said elongated part to the opening of said elongated tubular part proximal to said elongated flexible tubular interface, and wherein, proximal to said ring-shaped planar sealing surface, the radius of said elongated flexible tubular interface is larger than the radius of said elongated tubular part.

14. A process for pipetting liquid samples, comprising the steps of:
a) connecting a pipette to a pipette tip according to claim 1,
b) withdrawing liquid from a storage vessel,
c) dispensing said liquid into a new vessel by applying pneumatic pressure,
d) removing said pipette tip by mechanical pressure exerted by a solid part on the upper surface of the elongated flexible tubular interface of said pipette tip, and
e) connecting a pipette to said pipette tip, and repeating steps b) to d),
wherein step e) is performed at least once.

15. An analytical system comprising at least one module which comprises a pipette tip of claim 1.
